(19) United States
(12) Patent Application Publication
(10) Pub. No.: US 2007/0205286 A1
(43) Pub. Date: Sep. 6, 2007

(54) Portable multiple bar and other code display

(76) Inventor: Steven N. Verona, Margate City, NJ (US)

Correspondence Address: KREMBLAS, FOSTER, PHILLIPS & POLLICK, 7632 SLATE RIDGE BOULEVARD, REYNOLDSBURG, OH, 43068, US

(21) Appl. No.: 11/714,662

(22) Filed: Mar. 6, 2007

Related U.S. Application Data
(60) Provisional application No. 60/779,527, filed on Mar. 6, 2006.

(51) Int. Cl. G06K 7/10

(52) U.S. Cl. 235/462.01

(57) ABSTRACT

A device that records, stores and displays UPC's and other codes that are ordinarily stored on various cards. Thus, the device eliminates the need to carry multiple cards incorporating bar codes. By recording the image of the code, storing the image and being able to retrieve the code later, one has to carry only one device that can replace hundreds of bar code bearing cards.

### (e) BACKGROUND OF THE INVENTION

1. Field of the Invention

This invention relates to a device for recording and displaying multiple bar and other optically-read codes.

2. Description of the Related Art

It is well known that companies encourage customers to carry special credit card sized, or key ring attached, cards bearing a membership code that can be scanned optically. The motivation to carrying the cards is the possibility of discounts or other member benefits when purchases are made at the companies' stores. A typical situation is a grocery store that encourages its customers to obtain a membership card and display it for discounts when purchasing goods. The grocery store receives information about its customer's purchasing habits, and gives customers discounts in exchange. Thus, customers keep the cards in their possession when the possibility of shopping at the store exists.

Because most consumers shop at multiple stores, and because these consumers may become discount card members at each of those stores, each person must carry many cards in the event that they might shop at one of the stores of which they are a member. The large number of such cards can become unwieldy. Additionally, the cards can be scratched, making optical reading of the codes difficult. Therefore, the need arises for a device that makes carrying the necessary codes more convenient.

### (f) BRIEF SUMMARY OF THE INVENTION

Described herein is a method of displaying a code that is able to be optically scanned (an optically scanned code), such as a universal product code (UPC) and an apparatus for storing and displaying such a code. The method comprises inputting at least one optically scanned code into data storage means and storing the optically scanned code in the data storage means, such as a memory chip, hard drive or other data storage device. At least one optically scanned code is then selected and displayed on a display on the device. The displayed optically scanned code is then scanned using the scanner that would have scanned a card bearing the bar code.

The step of inputting preferably includes taking a digital photograph of the optically scanned code, uploading an electronic file and/or manually manipulating at least one finger-actuatable button on the device. The step of storing includes saving data in data storage means in the device, and the step of selecting includes manually manipulating at least one finger-actuatable button on the device or touching the display.

The invention contemplates obtaining an electronic image of each of a plurality of such optically scanned codes from cards, retaining the electronic image in a computer memory device, such as non-volatile random access memory (RAM) or the like, and then displaying the image when desired so that an optical scanner can read the image and identify the bearer thereof. This eliminates the need to carry many cards with the person. Instead, the user carries one device that is approximately the size of one of the cards, although thicker, that can display an image of all of the cards.

The purpose of the invention is to eliminate the need for carrying multiple identification cards incorporating bar codes or other optical images that can be scanned. Examples of such ID cards are membership tags from retail merchants that provide discounts to the users, gym membership cards, and employee membership cards. Of course, other such cards or identifying devices can be replaced by the invention.

### (g) BRIEF DESCRIPTION OF THE SEVERAL VIEWS OF THE DRAWINGS

FIG. 1 is a view in perspective illustrating a preferred embodiment of the present invention.

FIG. 2 is a view in perspective illustrating the device of FIG. 1 in a partially disassembled state in order to view the contents of the housing.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. For example, the word connected or terms similar thereto are often used. They are not limited to direct connection, but include connection through other elements where such connection is recognized as being equivalent by those skilled in the art.

### (h) DETAILED DESCRIPTION OF THE INVENTION

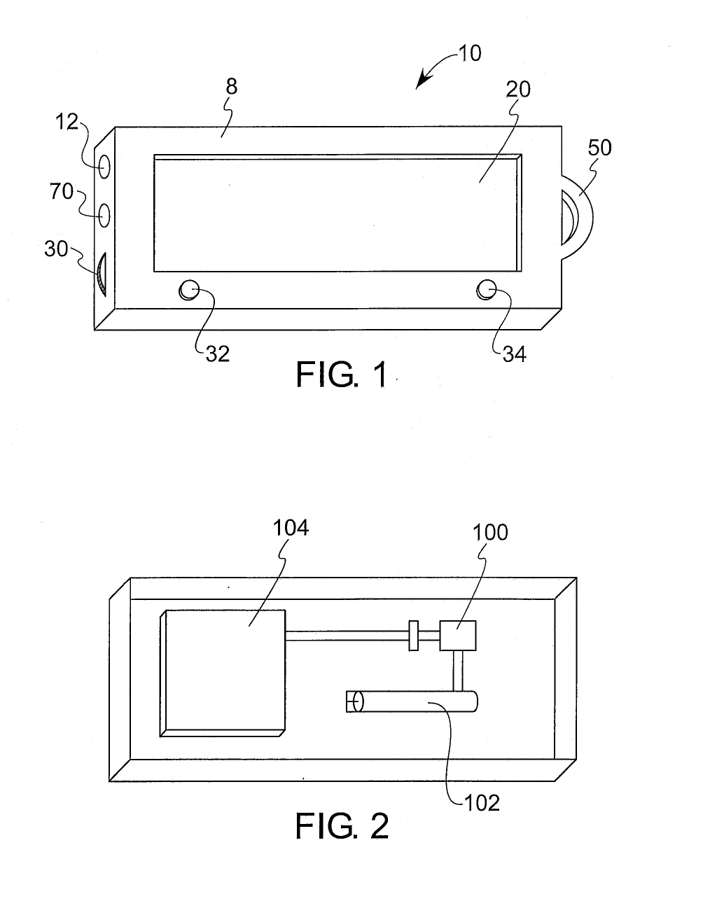

in a preferred embodiment shown in FIG. 1, the device 10 has a housing 8 that contains the structures associated with the invention. The housing is preferably a hollow plastic box, but can be made of metal, composite or any other suitable material. An optical recording apparatus is mounted to the housing in order to record the image on each bar or other optically scanned code-containing card. Preferably, the optical recording device is the camera lens 12 and associated hardware and software (not visible), but can be any suitable apparatus. Alternatively, the recording apparatus can be an input that permits uploading of a digital photograph, such as an infrared or other wireless communication port, or a socket into which a communication wire is plugged, such as a universal serial bus (USB).

The term “optically scanned code” is used herein to include any unique identification image, or system for creating such images, that can be displayed for scanning by an optical scanner. This includes, but is not limited to, universal product codes (UPC), also referred to as bar codes, but excludes radio frequency identification devices (RFTD) and magnetic strips that are identified by something other than optical scanning. The term “scanned” does not limit the codes to those that can be scanned into the device 10 using optics. This is because, in an alternative embodiment, the optically scanned image is input to the device 10 by typing in the numerical code, and software resident in the device 10 converts the numbers to the optically scanned image.

The device 10 includes a computer, such as a multipurpose programmable microprocessor 100 shown in FIG. 2, that operates according to software stored in a data storage device, such as the flash memory chip 104. Power can be supplied by a battery 102 or other source, such as a photovoltaic cell (not shown). Of course, the computer 100 can be replaced by a preprogrammed, single purpose computer or logic circuit. It will be understood by the person having ordinary skill that many different devices will accomplish the computing function of the invention. The computer 100 is connected to, and works in association with, the camera 12 to store the optically scanned images recorded on the memory chip 104. This is accomplished as in a conventional digital camera.

The device has a display 20 for displaying the optically scanned images with sufficient clarity to meet the requirements of the apparatus that will scan the displayed image, as discussed below. The display 20 is preferably a liquid crystal display (LCD) or similar device that forms an image on a surface, where the image can be optically perceived by a human or a machine. The concept of the display includes such technologies as projectors that project an image onto a surface or that appear to project the image into the air, as in a hologram. Any display means which can be read by an optical scanner will suffice, including, without limitation, an aligned array of light-emitting diodes (LEDs), cathode ray tube, electroluminescent panel, etc.

The device 10 includes an input for the user to control the operations, such as recording images, displaying images and other functions of the device 10. The input preferably includes a scrolling wheel 30, a pointer (such as a computer mouse-like controller) or a trackball 34 and button 32. Such inputs must be finger-actuatable, in order that a user can input to the device 10 under circumstances not involving another machine or device. By pressing the button 32, for example, one can take a photograph with the camera 12 and input instructions to the computer, such as to save the image. Additionally, one can input a name associated with the image that is recognizable to the user, such as the name of the store associated with the image. Still further, one can use the inputs to select which image to be displayed. The input can also be used to enter the numerical representation of the optically scanned code. Furthermore, the input device can be any suitable device, such as a conventional computer into which the optically scanned code is entered, and then downloaded to the device 10.

It is contemplated to use touch screen input technology on the display to input data, such as by creating touch tabs on the screen. Preferably, a portion of the step of selecting includes the computer 100 software displaying one or more images to the user regarding options for recording and displaying the images, options for organizing and naming the images, and other functions. Such options presented to the user can be selected by simply touching the display 20.

In order to use the invention, the user records at least two bar codes or other images using the device. This can be accomplished, preferably, by photographing the bar code with the camera 12, naming the image and storing the image in the memory. This can alternatively be accomplished using any of the other input steps described herein, or that will be apparent to the person of ordinary skill from reading this description. Carrying the preferred steps out starts with the device 10 being placed in close proximity to the card, pressing a button, such as the button 32, and instructing the computer 100 to record the image of the UPC (“bar”) code. For example, the bar code can be recorded and named “walmart” after the store supplying the card. This electronic image is stored in the memory of the device 10 along with at least one other image, which is preferably another bar or other optically-scanned code. This way, the device 10 replaces two or more cards bearing optically scanned codes.

The housing 8 preferably has a loop 50 that enables the user to attach the device 10 to his or her key chain, purse or other structure at one end. Thus, when the user needs to display the image in order to identify his or her optically scanned code image, he or she simply scrolls through the names of the images by pressing the button 32 or rotating the wheel 30, enters the appropriate image name when displayed, or inputs some other instruction to the device 10 so the image of that store's card is displayed on the display 20. For example, the user can enter a number representing the desired image.

Once selected, the image is displayed on the display 20. The user then uses a conventional code scanner to scan the image on the display 20 as he or she would scan the card itself. For example, the housing 8 can be passed under a beam of light, or a wand from which a beam of light is projected can be passed over the display 20. Of course, the user could simply type into the scanning device the numerical representation of the optically scanned code, as when the scanner will not read a conventional bar code. This scanning identifies the user, and accomplishes the same purpose as scanning the card. One significant advantage of the device 10 is that the housing 8 is the same exterior size regardless of how many optically scanned codes it contains. That is not so with the conventional cards. Preferably, the device 10 can store at least five, and preferably hundreds or more, codes.

The broad method thus involves the step of entering a bar code or other optically scanned code into the device 10. This could be accomplished by entering the alphanumeric or other identifying characters that the device 10 converts to a bar code or other optically scanned image. The bar code or other image is stored in the memory for later retrieval from the device. When it becomes desirable, one of the stored bar codes is selected for display on the display 20. The selected bar code or other optical image is displayed and then scanned by a conventional scanning device.

It will become apparent that many of the steps can be accomplished by other devices than those described. For example, the optical image can be recorded or entered by taking a photographic image of an existing bar code, entering the corresponding number which the bar code represents, or scanning the bar code using a conventional scanner. Other technology will present other known procedures for loading the images into the memory of the device. Additionally, any data storage means can be used to store the image recorded or the image created by the device.

In an alternative embodiment, the elements of the device 10 are incorporated into an existing apparatus that has some or many of the features of the invention. For example, many cellular telephones have cameras, memory, devices for scrolling through saved images, and displays for displaying images. Thus, in such a situation the method described above is carried out using these devices. Other electronic devices, including but not limited to personal digital assistants (PDAs), notebook computers, and other machines, can be used. A special purpose device incorporating the invention can, of course, have additional features incorporated therein, such as a flashlight 70 and the loop 50 for attaching the housing 8 to a key chain. The flashlight 70 is connected to the battery 102, and the button 32.

This detailed description in connection with the drawings is intended principally as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. A method of displaying an optically scanned code, the method comprising:
(a) inputting at least two optical codes into data storage means in a device;
(b) selecting one of said at least two optical codes;
(c) displaying the selected optical code on a display on the device; and
(d) scanning the display.

2. The method in accordance with claim 1, wherein the step of inputting further comprises taking a digital photograph of the optical code.

3. The method in accordance with claim 1, wherein the step of inputting further comprises uploading an electronic file to the device.

4. The method in accordance with claim 1, wherein the step of inputting further comprises manually manipulating at least one finger-actuatable button on the device.

5. The method in accordance with claim 4, wherein the step of inputting further comprises saving data associated with the optical code in data storage means in the device.

6. The method in accordance with claim 1, wherein the step of inputting further comprises touching the display.

7. The method in accordance with claim 1, wherein the step of selecting further comprises manually manipulating at least one finger-actuatable button on the device.

8. The method in accordance with claim 1, wherein the step of selecting further comprises touching the display.

9. The method in accordance with claim 1, wherein the step of scanning further comprises placing the device's display in a scanning device's field.

10. An apparatus for storing and displaying optically scanned codes, the apparatus comprising:
(a) means for inputting at least two optical codes into data storage means in the device;
(b) means for selecting at least one of said at least two optical codes; and
(c) means for displaying the selected optical code on a display.

11. An apparatus for storing and displaying optically scanned codes, the apparatus comprising:
(a) a housing;
(b) a computer within the housing;
(c) at least one finger-actuatable button on the housing that is connected to the computer; and
(d) a display screen on the housing and connected to the computer, for displaying an optically scanned code.

12. The apparatus in accordance with claim 11, further comprising a camera mounted on the housing and connected to the computer.

13. The apparatus in accordance with claim 11, further comprising a loop mounted to the housing.

14. The apparatus in accordance with claim 13, further comprising a visible light emitting device mounted to the housing and connected to said at least one finger-actuatable button.
